(19) United States
(12) Patent Application Publication
(10) Pub. No.: US 2012/0023936 A1
(43) Pub. Date: Feb. 2, 2012

(54) NOZZLED TURBOCHARGER TURBINE

(75) Inventors: RICHARD W. KRUISWYK, Dunlap, IL (US); KERRY A. DELVECCHIO, Dunlap, IL (US); PAUL W. REISDORF, Dunlap, IL (US); DAVID A. PIERPONT, Dunlap, IL (US); STEVE O'HARA, Zionsville, IN (US)

(73) Assignee: CATERPILLAR INC., PEORIA, IL (US)

(21) Appl. No.: 13/191,704

(22) Filed: Jul. 27, 2011

Related U.S. Application Data
(60) Provisional application No. 61/369,147, filed on Jul. 30, 2010.

(51) Int. Cl. F02B 33/44; F01D 1/02

(52) U.S. Cl. 60/605.2; 415/199.2

(57) ABSTRACT

A turbine includes a turbine housing (215) including at least two gas passages (236) having substantially the same flow area and disposed on either side of at least one divider wall (240). A turbine wheel (212) includes a plurality of blades (214). A nozzle ring (238) is connected to the turbine housing (215) and disposed around the turbine wheel. The nozzle ring (238) includes an inner ring (242) disposed adjacent the divider wall (240) and at least one outer ring (238). A plurality of vanes (246) is fixedly disposed between the inner and outer rings. The vanes define a plurality of inlet openings (258) therebetween that are in fluid communication with a slot (230) formed in the ring and surrounding the turbine wheel (212). The inner ring (242) is disposed to block a portion of the inlet openings (258) that fluidly communicate with one of the at least two gas passages (236) in the turbine housing (215).

### CROSS-REFERENCE TO RELATED APPLICATIONS FIELD

This patent application claims the benefit of U.S. Provisional Patent Application No. 61/369,147, filed Jul. 30, 2010, which is incorporated herein in its entirety by this reference.

### TECHNICAL FIELD

This patent disclosure relates generally to turbochargers for use with internal combustion engines and, more particularly, to turbochargers used on internal combustion engines.

### BACKGROUND

Internal combustion engines are supplied with a mixture of air and fuel for combustion within the engine that generates mechanical power. To maximize the power generated by this combustion process, the engine is often equipped with a turbocharged air induction system.

A turbocharged air induction system includes a turbocharger that uses exhaust from the engine to compress air flowing into the engine, thereby forcing more air into a combustion chamber of the engine than the engine could otherwise draw into the combustion chamber. This increased supply of air allows for increased fuelling, resulting in an increased engine power output.

The fuel energy conversion efficiency of an engine depends on many factors, including the efficiency of the engine's turbocharger. Previously proposed turbocharger designs include turbines having separate gas passages formed in their housings. In such turbines, two or more gas passages may be formed in the turbine housing and extend in parallel to one another such that exhaust pulse energy fluctuations from individual engine cylinders firing at different times are preserved as the exhaust gas passes through the turbine. These exhaust pulses can be used to improve the driving function of the turbine and increase its efficiency.

Internal combustion engines also use various systems to reduce certain compounds and substances that are byproducts of the engine's combustion. One such system, which is commonly known as exhaust gas recirculation (EGR), is configured to recirculate metered and often cooled exhaust gas into the intake system of the engine. The combustion gases recirculated in this fashion have considerably lower oxygen concentration than the fresh incoming air. The introduction of recirculated gas in the intake system of an engine and its subsequent introduction in the engine cylinders results in lower combustion temperatures being generated in the engine, which in turn reduces the creation of certain combustion byproducts, such as compounds containing oxygen and nitrogen.

One known configuration for an EGR system used on turbocharged engines is commonly referred to as a high pressure EGR system. The high pressure designation is based on the locations in the engine intake and exhaust systems between which exhaust gas is recirculated. In a high pressure EGR system (HP-EGR), exhaust gas is removed from the exhaust system from a location upstream of a turbine and is delivered to the intake system at a location downstream of a compressor. When entering the intake system, the recirculated exhaust gas mixes with fuel and fresh air from the compressor and enters the engine's cylinders for combustion.

In engines lacking specialized components, such as pumps, that promote the flow of EGR gas between the exhaust and intake systems of the engine, the maximum possible flow rate of EGR gas through the EGR system will depend on the pressure difference between the exhaust and intake systems of the engine. This pressure difference is commonly referred to as the EGR driving pressure. It is often the case that engines require a higher flow of EGR gas than what is possible based on the EGR driving pressure present during engine operation.

In the past, various solutions have been proposed to selectively adjust the EGR driving pressure in turbocharged engines. One such solution has been the use of variable nozzle or variable geometry turbines. A variable nozzle turbine includes moveable blades disposed around the turbine wheel. Motion of the vanes changes the effective flow rate of the turbine and thus, in one aspect, creates a restriction that increases the pressure of the engine's exhaust system during operation. The increased exhaust gas pressure of the engine results in an increased EGR driving pressure, which in turn facilitates the increased flow capability of EGR gas in the engine.

Although such and other known solutions to increase the EGR gas flow capability of an engine have been successful and have been widely used in the past, they require use of a variable geometry turbine, which is a relatively expensive device that includes moving parts operating in a harsh environment. Moreover, variable geometry turbines typically destroy or mute the pulse energy of the exhaust gas stream of the engine, which results in lower turbine efficiency and higher fuel consumption.

### SUMMARY

The disclosure describes, in one aspect, a turbine. The turbine includes a turbine housing having at least two gas passages having substantially the same flow area and disposed on either side of at least one divider wall, and a turbine wheel having a plurality of blades. A nozzle ring is connected to the turbine housing and disposed around the turbine wheel. The nozzle ring includes an inner ring disposed adjacent the divider wall and at least one outer ring. A plurality of vanes is fixedly disposed between the inner and outer rings. The vanes define a plurality of inlet openings therebetween that are in fluid communication with a slot formed in the ring that surrounds the turbine wheel. The inner ring is disposed to block a portion of the inlet openings that fluidly communicate with one of the at least two gas passages in the turbine housing.

In another aspect, the disclosure describes an internal combustion engine. The engine includes a divided turbine having first and second inlets. A first plurality of is cylinders connected to a first exhaust conduit, which is connected to the first inlet of the divided turbine. A second plurality of cylinders is connected to a second exhaust conduit, which is connected to the second inlet of the divided turbine. A balance valve is disposed to selectively route exhaust gas from the first exhaust conduit to the second exhaust conduit. An exhaust gas recirculation (EGR) system includes a valve that selectively fluidly connects the first exhaust conduit with an intake system of the engine. The divided turbine includes a turbine housing having at least two gas passages having substantially the same flow area and disposed on either side of at least one divider wall, and a turbine wheel having a plurality of blades. A nozzle ring is connected to the turbine housing and disposed around the turbine wheel. The nozzle ring includes an inner ring disposed adjacent the divider wall and at least one outer ring. A plurality of vanes is fixedly disposed between the inner and outer rings. The vanes define a plurality of inlet openings therebetween that are in fluid communication with a slot formed in the ring that surrounds the turbine wheel. The inner ring is disposed to block a portion of the inlet openings that fluidly communicate with one of the at least two gas passages in the turbine housing.

In yet another aspect, the disclosure describes a nozzle ring for a turbine. The nozzle ring includes an inner ring disposed adjacent a divider wall of a turbine housing when the nozzle ring is disposed within the turbine housing. The inner ring defines a divider wall extension having a generally trapezoidal shape that includes a substantially flat base, which is adapted to be disposed adjacent the divider wall. The nozzle ring further defines a rounded base and two generally straight edges connected to the flat base and tangentially meeting the ends of the rounded base when viewed in section taken along a diameter of the nozzle ring. At least one outer ring has a radial thickness and is disposed at an axial distance relative to the inner ring. A plurality of vanes is fixedly disposed between the inner and outer rings. The vanes define a plurality of inlet openings therebetween that are adapted to be in fluid communication with one or more gas passages defined in the turbine housing. The divider wall extension portion has a radial thickness of about 40% of the total radial thickness of the at least one outer ring, and is slanted by about 60 degrees relative to the flat base such that one of the two straight edges is about 60% of the length of the other of the two straight edges. A radius of the rounded base is about 16% of the length of the longer of the two straight edges and about 25% of the length of the shorter of the two straight edges.

### BRIEF DESCRIPTION OF THE DRAWINGS

FIG. 1 is a block diagram of an internal combustion engine having a high pressure EGR system in accordance with the disclosure.

FIG. 2 is a section of a turbocharger assembly in accordance with the disclosure.

FIG. 3 is a detail section of a turbine assembly in accordance with the disclosure.

FIG. 4 is an outline view of a radial nozzle ring in accordance with the disclosure.

FIG. 5 is a section of a nozzle ring in accordance with the disclosure

FIGS. 6-8 are detail sections of different embodiments of nozzle ring configurations in accordance with the disclosure.

FIGS. 9 and 10 are sections of a turbine housing in accordance with the disclosure.

FIG. 11 is an outline view of a turbine wheel in accordance with the disclosure.

FIG. 12 is a cross section of a radial nozzle turbine in accordance with the disclosure.

FIG. 13 is a cross section of a mixed flow nozzle turbine in accordance with the disclosure.

FIGS. 14 and 15 are diagrammatic nozzle flow profile charts in accordance with the disclosure.

FIG. 16 is an alternative embodiment for a turbine housing in accordance with the disclosure.

FIG. 17 a chart comparing turbine efficiency data in accordance with the disclosure.

### DETAILED DESCRIPTION

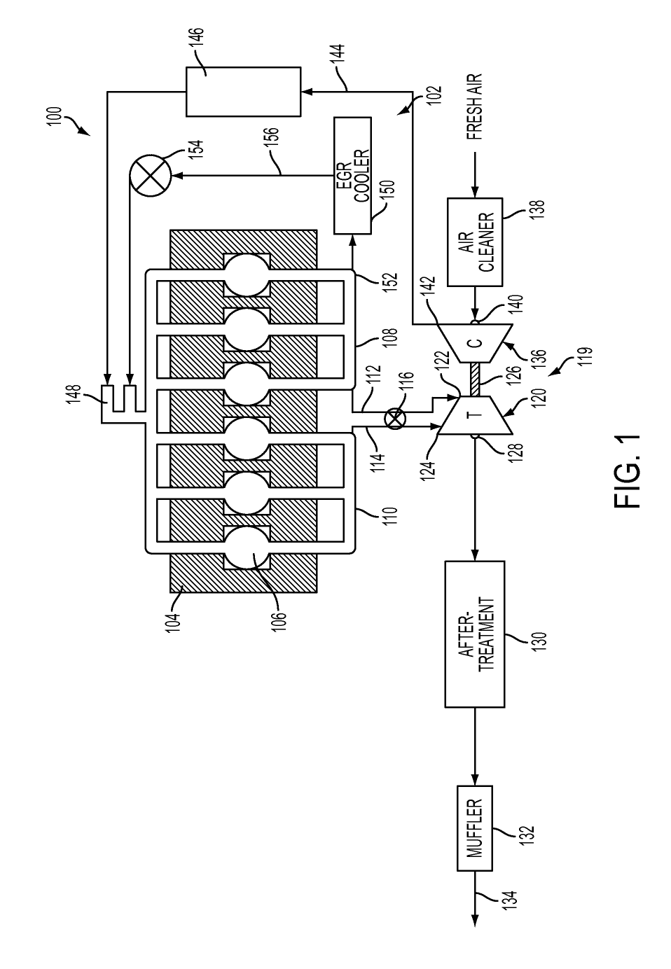

This disclosure relates to an improved turbine configuration used in conjunction with a turbocharger in an internal combustion engine to promote the engine's efficiency and ability to drive sufficient amounts of EGR gas. A simplified block diagram of an engine 100 having a high pressure EGR system 102 is shown in FIG. 1. The engine 100 includes a crankcase 104 that houses a plurality of combustion cylinders 106. In the illustrated embodiment, six combustion cylinders are shown in an inline configuration, but any other number of cylinders arranged in a different configuration such as a “V” configuration may be used. The plurality of cylinders 106 is fluidly connected via exhaust valves (not shown) to first and second exhaust conduits 108 and 110. Each of the first and second exhaust conduits 108 and 110 is connected to a respective exhaust pipe 112 and 114, which are in turn connected to a turbine 120 of a turbocharger 119. A balance valve 116 is fluidly interconnected between the two exhaust pipes 112 and 114 and is arranged to route exhaust gas from the first exhaust pipe 112 to the second exhaust pipe 114 as necessary during operation. It is noted that the balance valve 116 is optional and may be omitted.

In the illustrated embodiment, the turbine 120 has a separated housing, which includes a first inlet 122 fluidly connected to the first exhaust pipe 112, and a second inlet 124 connected to the second exhaust pipe 114. Each inlet 122 and 124 is disposed to receive exhaust gas from one of the first and second exhaust conduits 108 and 110 during engine operation. The exhaust gas operates to cause a turbine wheel (not shown here) connected to a shaft 126 to rotate before exiting the turbine 120 through an outlet 128. The exhaust gas at the outlet 128 is optionally passed though other exhaust components, such as an after-treatment device 130 that mechanically and chemically removes combustion byproducts from the exhaust gas stream, and/or a muffler 132 that dampens engine noise, before being expelled to the environment through a stack or tail pipe 134.

Rotation of the shaft 126 causes the wheel (not shown here) of a compressor 136 to rotate. As shown, the compressor 136 is a radial compressor configured to receive a flow of fresh, filtered air from an air filter 138 through a compressor inlet 140. Pressurized air at an outlet 142 of the compressor 136 is routed via a charge air conduit 144 to a charge air cooler 146 before being provided to an intake manifold 148 of the engine 100. In the illustrated embodiment, air from the intake manifold 148 is routed to the individual cylinders 106 where it is mixed with fuel and combusted to produce engine power.

The EGR system 102 includes an optional EGR cooler 150 that is fluidly connected to an EGR gas supply port 152 of the first exhaust conduit 108. A flow of exhaust gas from the first exhaust conduit 108 can pass through the EGR cooler 150 where it is cooled before being supplied to an EGR valve 154 via an EGR conduit 156. The EGR valve 154 may be electronically controlled and configured to meter or control the flow rate of the gas passing through the EGR conduit 156. An outlet of the EGR valve 154 is fluidly connected to the intake manifold 148 such that exhaust gas from the EGR conduit 156 may mix with compressed air from the charge air cooler 146 within the intake manifold 148 of the engine 100.

The pressure of exhaust gas at the first exhaust conduit 108, which is commonly referred to as back pressure, is higher than ambient pressure because of the flow restriction presented by the turbine 120. For the same reason, a positive backpressure is present in the second exhaust conduit 110. The pressure of the air or the air/EGR gas mixture in the intake manifold 148, which is commonly referred to as boost pressure, is also higher than ambient because of the compression provided by the compressor 136. In large part, the pressure difference between back pressure and boost pressure, coupled with the flow restriction of the components of the EGR system 102, determine the maximum flow rate of EGR gas that may be achieved at various engine operating conditions.

For this reason, the backpressure at the first exhaust conduit 108 is maintained at a higher level than the back pressure at the second exhaust conduit 110 at times during engine operation when additional EGR driving pressure is desired. To accomplish this pressure increase, the turbine 120 is configured to have different exhaust gas flow restriction characteristics, with the flow entering through the first inlet 122 being subject to a higher flow restriction than the flow entering through the second inlet 124. This different or asymmetrical flow restriction characteristic of the turbine 120 provides an increased pressure difference to drive EGR gas without increasing the backpressure of substantially all cylinders 106 of the engine 100. At times when no back pressure increase is desired in the first exhaust conduit 108 to drive EGR gas flow, the optional balance valve 116 may be used to balance out the exhaust flow through each of the two inlets 122 and 124 of the turbine 120.

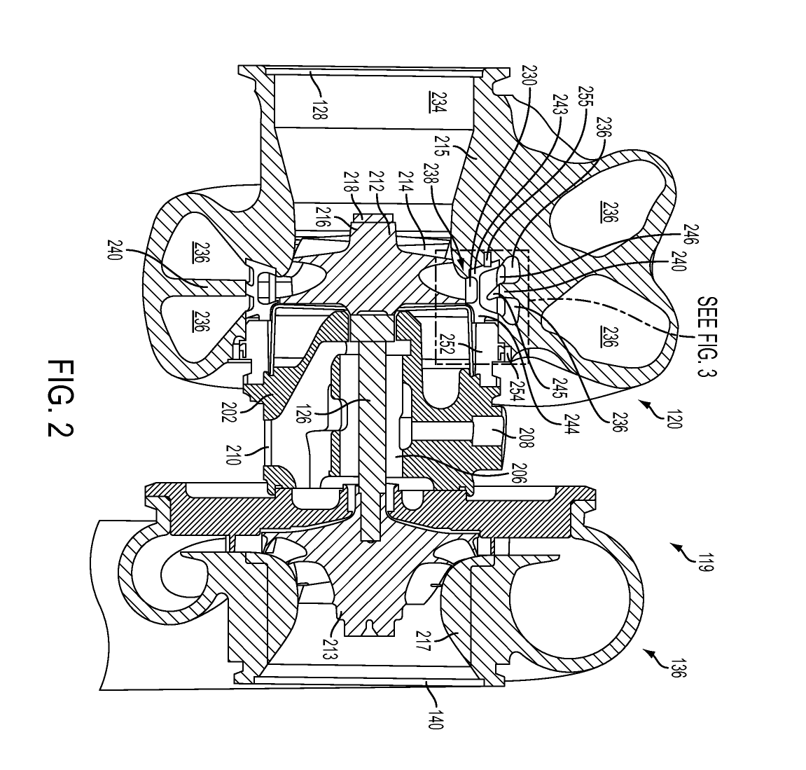

In the description that follows, structures and features that are the same or similar to corresponding structures and features already described are denoted by the same reference numerals as previously used for simplicity. Accordingly, a cross section of one embodiment of the turbocharger 119 is shown in FIG. 2. The turbocharger 119 includes the turbine 120 and compressor 136 that are connected to one another via a center housing 202. As shown, the center housing 202 surrounds a portion of the shaft 126 and includes a bearing (not shown) disposed within a lubrication cavity 206. The lubrication cavity 206 includes lubricant inlet and outlet openings 208 and 210 that provide lubrication to the bearing as the shaft 126 rotates during operation.

The shaft 126 is connected to a turbine wheel 212 at one end and to a compressor wheel 213 at another end. The turbine wheel 212 is configured to rotate within a turbine housing 215 that is connected to the center housing 202. The compressor wheel 213 is disposed to rotate within a compressor housing 217. The turbine wheel 212 includes a plurality of blades 214 radially arranged around a hub 216. The hub 216 is connected to an end of the shaft 126 by a fastener 218 and is configured to rotate the shaft 126 during operation. A detailed outline view of the turbine wheel 212 is shown in FIG. 11. The turbine wheel 212 is rotatably disposed between an exhaust gas inlet slot 230 defined within the turbine housing 215. The slot 230 provides exhaust gas to the turbine wheel 212 in a radial direction along the leading edges 222 of the blades 214. Exhaust gas exiting the turbine wheel 212 is provided to a turbine outlet bore 234 that is fluidly connected to the turbine outlet 128. The gas inlet slot 230 is fluidly connected to inlet gas passages 236 formed in the turbine housing 215 and configured to fluidly interconnect the gas inlet slot 230 with the turbine inlets 122 and 124 (FIG. 1).

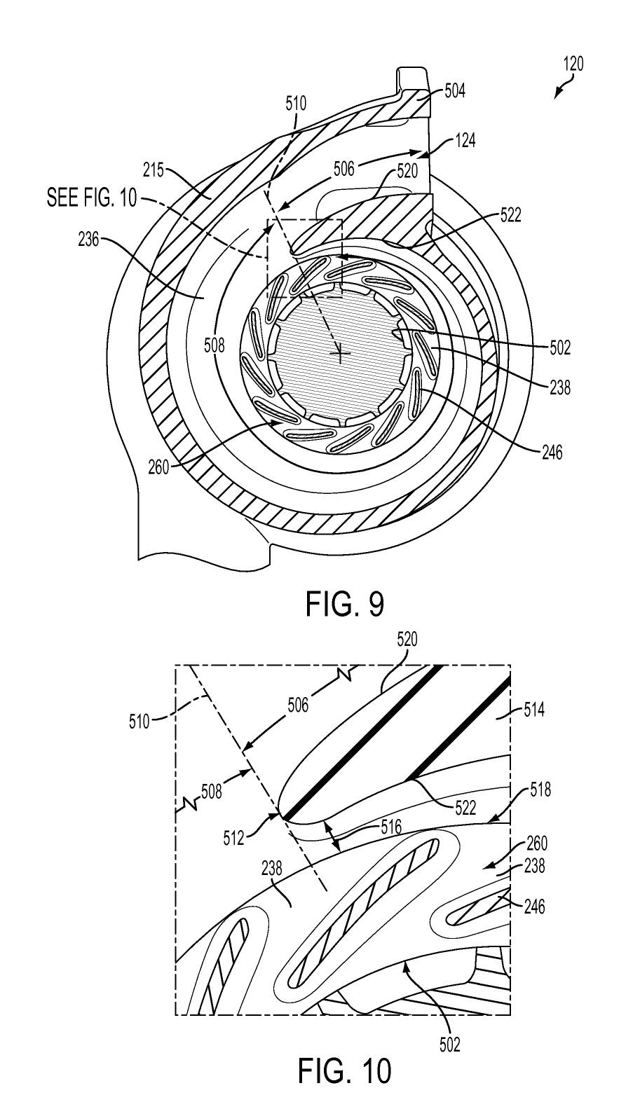

Each of the two turbine inlets 122 and 124 is connected to one of two inlet gas passages 236. Each gas passage 236 has a generally scroll shape that is wrapped around the area of the turbine wheel 212 and bore 234 and is open to the slot 230 around the entire periphery of the turbine wheel 212. The cross sectional flow area of each passage 236 decreases along a flow path of gas entering the turbine 120 via the inlets 122 and 124 and exiting the housing through the slot 230, as is generally shown in FIG. 9 that follows. As shown, the two passages 236 have substantially the same cross sectional flow area at any given radial location around the wheel 212. Although two passages 236 are shown, a single or more than two passages may be used.

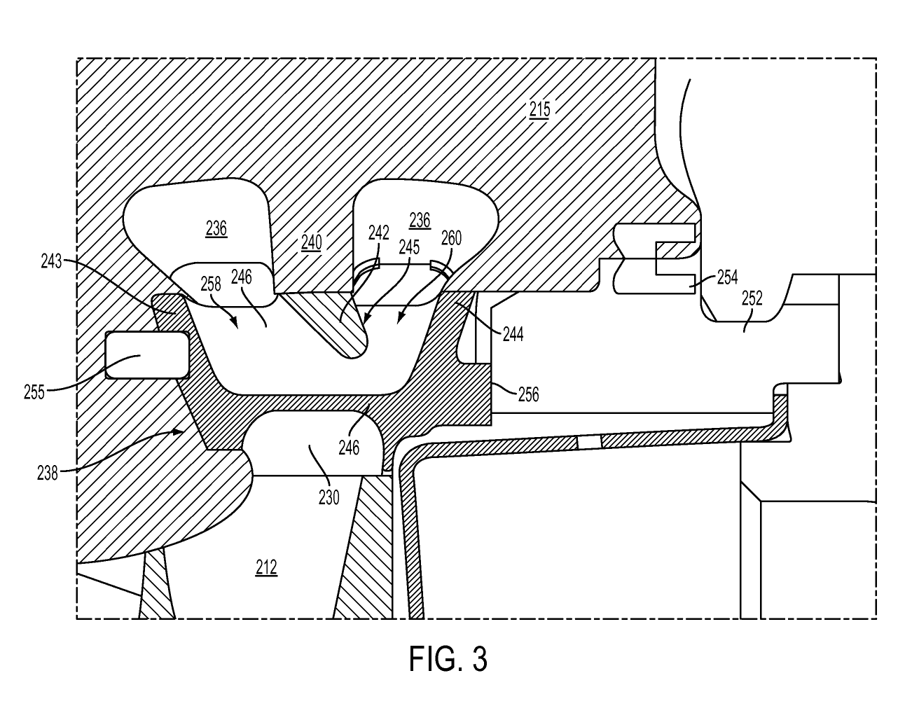

A radial nozzle ring 238 is disposed substantially around the entire periphery of the turbine wheel 212. As will be discussed in more detail in the paragraphs that follow, the radial nozzle ring 238 is disposed in fluid communication with both passages 236 and defines the slot 230 around the wheel 212. As shown in FIG. 2 and in the detailed view of FIG. 3, a divider wall 240 is defined in the housing 215 between the two passages 236. The divider wall 240 is disposed radially outwardly relative to the slot 230 such that gas flow from the two passages 236 may be combined before entering the slot 230 and reaching the wheel.

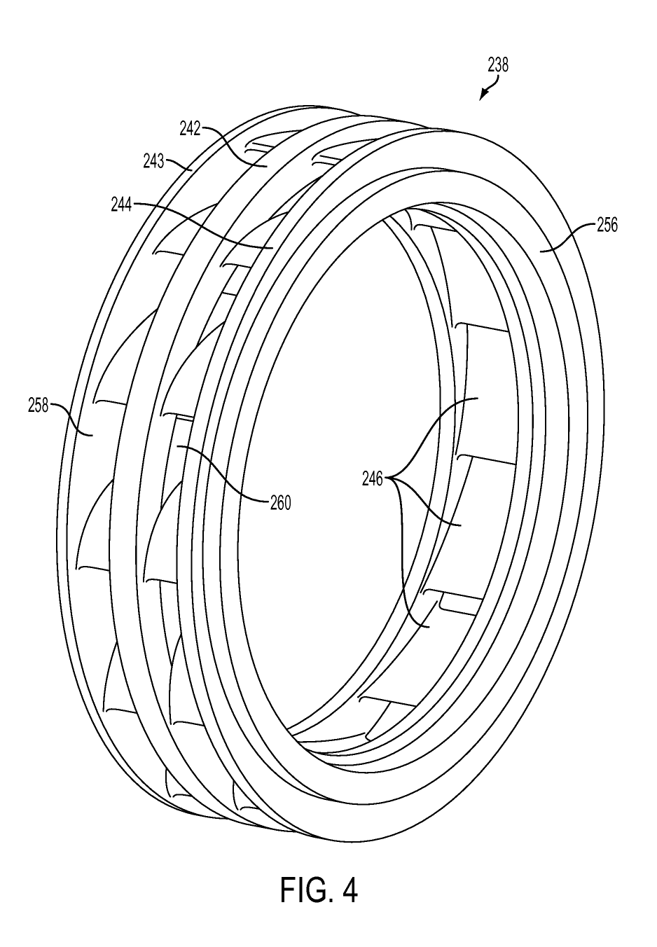

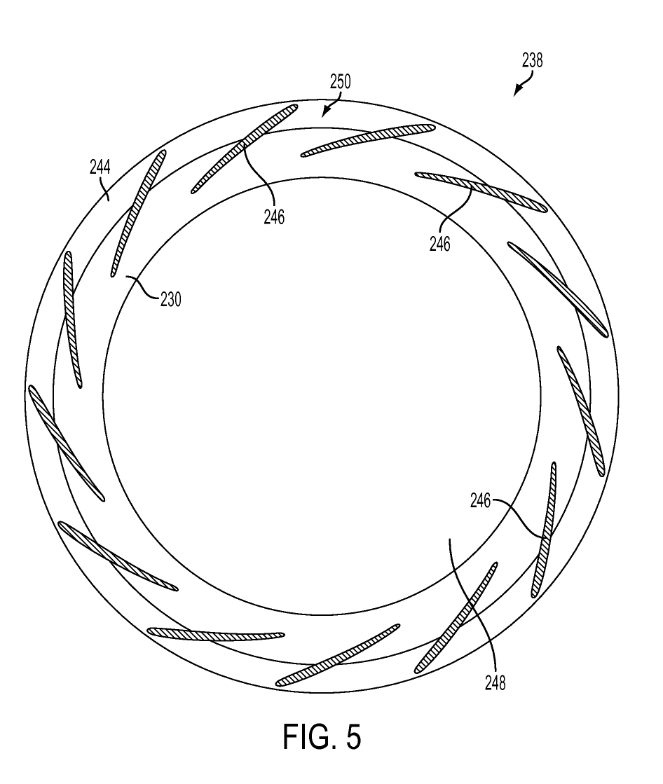

In further reference to FIGS. 4 and 5, the nozzle ring 238 includes an inner ring 242 disposed between two outer rings, namely a first outer ring 243 and a second outer ring 244. The inner ring 242 is positioned adjacent the divider wall 240 and forms an extension thereof, as shown in FIG. 3, to form a divider wall extension portion 245. In the illustrated embodiment, the inner ring 242 has an asymmetrical shape that provides different flow areas between each of the first and second outer rings 243 and 244 and the inner ring 242 for gas passing through each of the two passages 236 into the slot 230. A plurality of vanes 246 is symmetrically disposed between the first and second outer rings 243 and 244 and intersect the inner ring 242 as they extend axially along the rotation axis of the turbine wheel 212.

The shape and configuration of the vanes 246 can be best seen in the cross section of FIG. 5. As shown, the vanes 246 are arranged symmetrically around a central opening 248 of the ring 238 such that inclined flow channels 250 are defined between adjacent vanes 246. The flow momentum of gas passing through the channels 250 is directed generally tangentially and radially inward towards an inner diameter of the wheel 212 (shown in FIG. 2) such that wheel rotation may be augmented. Although the vanes 246 further have a generally curved airfoil shape to minimize flow losses of gas passing over and between the vanes 246, thus providing uniform inflow conditions to the turbine wheel, they also provide structural support to the inner ring 242. In the illustrated embodiment there are thirteen vanes connected to the ring 238, but any other number of rings may be used. In a preferred embodiment, the number of vanes 246 is different than the number of blades 214 such that resonance conditions are avoided during operation.

Returning now to FIG. 2, the nozzle ring 238 is disposed within a bore formed in the turbine housing 215. A retainer 252 is disposed to retain the ring 238 within the housing 215. The retainer 252 extends peripherally around the ring 238 and is retained to the housing by one or more fasteners 254. Further, one or more pins 255 disposed in corresponding cavities formed in the housing and in the ring 238 may be used to properly orient the nozzle ring 238 relative to the housing 215 during assembly. The nozzle ring 238 may have a clearance fit with the bore of the housing 215 such that sufficient clearance is provided for thermal growth of each component during operation to minimize thermal stresses.

As best shown in FIG. 3, the second outer ring 244 of the nozzle ring 238 defines a contact pad 256 that abuts the retainer 252. The contact pad 256 is disposed to provide axial engagement of the nozzle ring 238 with the housing 215. The illustrated configuration of the nozzle ring 238 includes two pluralities of inlet openings 258 and 260, each of which is defined between adjacent vanes 246, the inner ring 242, and the corresponding first or second outer rings 243 or 244. Accordingly, a first plurality of inlet openings 258 is defined between the first outer ring 243 and the inner ring 242, and a second plurality of inlet openings 260 is defined between the inner ring 242 and the second outer ring 244.

As shown, each of the first plurality of inlet openings 258 is in fluid communication with the gas passage 236 shown on the left side of the illustration of FIG. 3. The inlet openings 258 permit the substantially unobstructed flow of gas therethrough. However, the inclination of the divider wall extension portion 245 of the inner ring 242, which is towards the right in the illustration of FIG. 3, reduces or obstructs a portion of the flow area of each of the second plurality of inlet openings 260.

The reduced flow opening of the second plurality of inlet openings 260 as compared to the first plurality of inlet openings 258 provides an asymmetrical flow restriction to gas present in one of the gas passages 236 over the other. In the embodiment shown and in further reference to FIG. 1, the turbine inlet 122 that is fluidly connected to the first exhaust conduit 108 is configured to be in fluid communication with the second plurality of inlet openings 260. The turbine inlet 124 that is fluidly connected to the second exhaust conduit 110 is correspondingly in fluid communication with the first plurality of inlet openings 258. Notwithstanding any flow diversion that may be selectively provided by the balance valve 116 (FIG. 1) between the two turbine inlets 122 and 124 during operation, the reduced flow area corresponding to the second plurality of inlet openings 260 in the turbine will provide an increased gas pressure in the first exhaust conduit 108 such that the flow of EGR gas may be augmented, as previously described.

Therefore, the unique flow characteristics of the turbine 120 may be determined by the size, shape, and configuration of the nozzle ring 238 while other portions of the turbine may advantageously remain unaffected or, in the context of designing for multiple engine platforms, the remaining portions of the turbine may remain substantially common for various engines and engine applications. Accordingly, the specific symmetrical or asymmetrical flow characteristics of a turbine that is suited for a particular engine system may be determined by combining a turbine, which otherwise may be common for more than one engine, with a particular nozzle ring having a configuration that is specifically suited for that particular engine system.

The customization capability provided by a specialized nozzle ring in an otherwise common turbocharger assembly presents numerous advantages over known turbochargers. First, an engine or parts manufacturer may streamline its production by reducing the number of different turbochargers that are manufactured. In this way, waste, inventory, and costs may be reduced in the market for original and service parts. Moreover, parts may remain common even when other surrounding components and systems, such as the EGR system, undergo changes to keep up with changing performance demands. Even further, low production number engine applications, which may otherwise not have a specialized turbocharger manufactured to optimally suit them because of cost considerations, may now be more easily customized at a lower cost by simply incorporating a unique nozzle ring in an otherwise common turbocharger. These and other advantages may be realized by use of interchangeable rings for turbines as set forth herein.

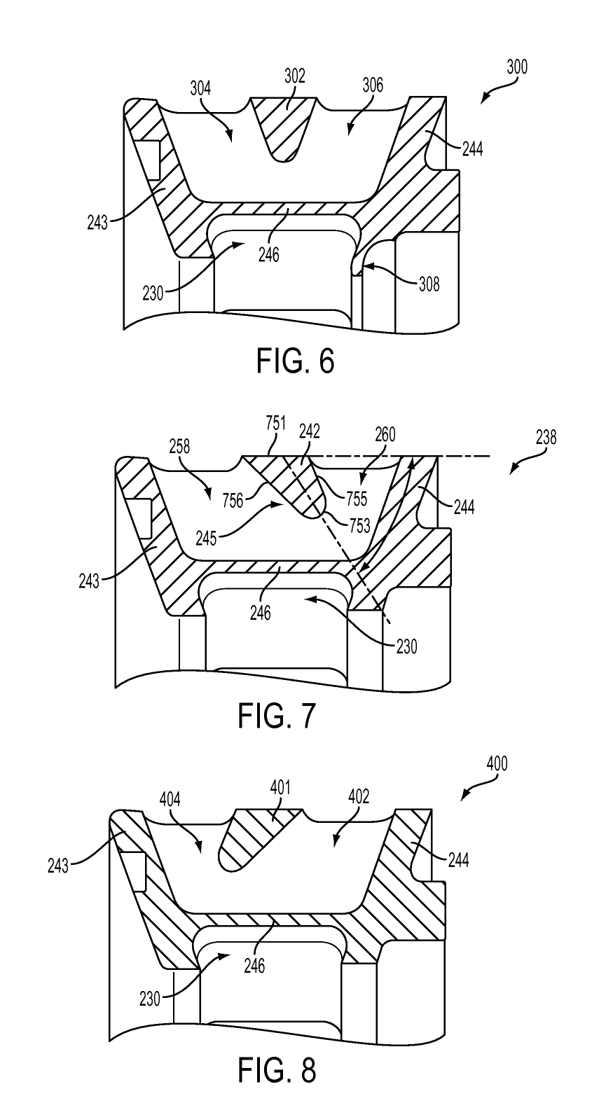

Based on the foregoing, it should be clear that the nozzle rings may be tailored in numerous configurations to provide a desired flow restriction and flow characteristics for the turbocharger in which they are installed. Accordingly, three different embodiments of nozzle rings are shown in partial cross section in FIGS. 6-8. In the description that follows, structures or features that are the same or similar as corresponding structures or features previously described are denoted by the same reference numerals as previously used for simplicity. The nozzle ring shown in FIG. 7 is the same as the nozzle ring 238 previously described, which is shown here to illustrate certain differences in the structures of the nozzle rings shown in FIGS. 6 and 8 both to one another as well as to the nozzle ring 238 (FIG. 7).

Accordingly, a first alternative embodiment of a nozzle ring 300 is shown in FIG. 6. The nozzle ring 300 includes first and second outer rings 243 and 244 disposed on either side of an inner ring 302. Unlike the asymmetrical flow characteristics between the two pluralities of inlet openings 258 and 260 discussed previously relative to the nozzle ring 238 (FIG. 7), the nozzle ring 300 (FIG. 6) has a substantially balanced flow characteristic. More specifically, the nozzle ring 300 includes two pluralities of inlet openings 304 and 306, which are defined between the vanes 246, the sides of the inner ring 302 and the corresponding side of the first and second outer rings 243 and 244. Given the symmetrical shape of the divider wall extension provided by the inner ring 302, the flow area of each of the two pluralities of inlet openings is substantially equal. When coupled with the substantially equal flow areas between the two gas passages 236 (FIG. 2), use of the nozzle ring 300 will provide a substantially equal flow restriction between the two inlets 122 and 124 of the turbine 120 (FIG. 1).

The nozzle ring 300 further includes an outer ring extension 308 that is connected to the second outer ring 244 and that extends radially inward alongside the corresponding side of the slot 230, as shown in FIG. 6. In certain embodiments, the extension 308 may provide additional direction to gases passing through the slot 230 towards the blades 214 of the turbine wheel 212 (FIG. 2) to increase the efficiency of the turbine.

A second alternative embodiment of a nozzle ring 400 is shown in FIG. 8. In this embodiment, the divider wall extension provided by the inner ring 401 is asymmetrical to create a difference in flow area between first and second pluralities of inlet openings 402 and 404 that is roughly inverse to that of the ring 238 (FIG. 7). In other words, where the ratio of flow areas in the ring 238 is about 70/30, expressed as a percentage, the corresponding ratio of flow areas in the ring 400 is about 30/70. It is contemplated that any desired ratio may be accomplished in the flow areas of inlet openings disposed on either side of the inner ring. For instance, the ratio may not only be anywhere between 30/70 and 70/30 as shown here, but any other ratio may be used by appropriately positioning and shaping the inner ring relative to the outer rings. Moreover, although the asymmetry in the illustrated embodiments is accomplished by providing a slanted inner ring relative to the first or second outer rings 243 or 244, other methods may be used such as differently shaped inner ring cross sections and others.

As shown, for example, in FIG. 7, the divider wall extension portion 245 of the inner ring 242 has a generally oblique trapezoidal shape having a flat base 751, along which it contacts the divider wall, and a generally rounded opposite base 753. In the illustrated embodiment, the radial thickness of the divider wall extension portion 245 is about 40% of the total radial thickness of each of the first and second outer rings 243 and 244. The bases 751 and 753 are connected by two straight edges 755 and 756 that extend tangentially relative to the rounded base 753. As shown, the length of the shorter edge 755, is about 60% of the length of the longer of the two edges 756, while the radius of the rounded base 753 is about 16% of the length of the longer of the two edges 756 and about 25% of the length of the shorter of the two edges 755. In the embodiment shown in FIG. 7, the divider wall extension portion 245 is disposed at an angle of about 60 degrees relative to the flat base 751 but other angles to yield different flow asymmetry may be used. Moreover, shapes other than oblique trapezoids having a rounded base may also be used.

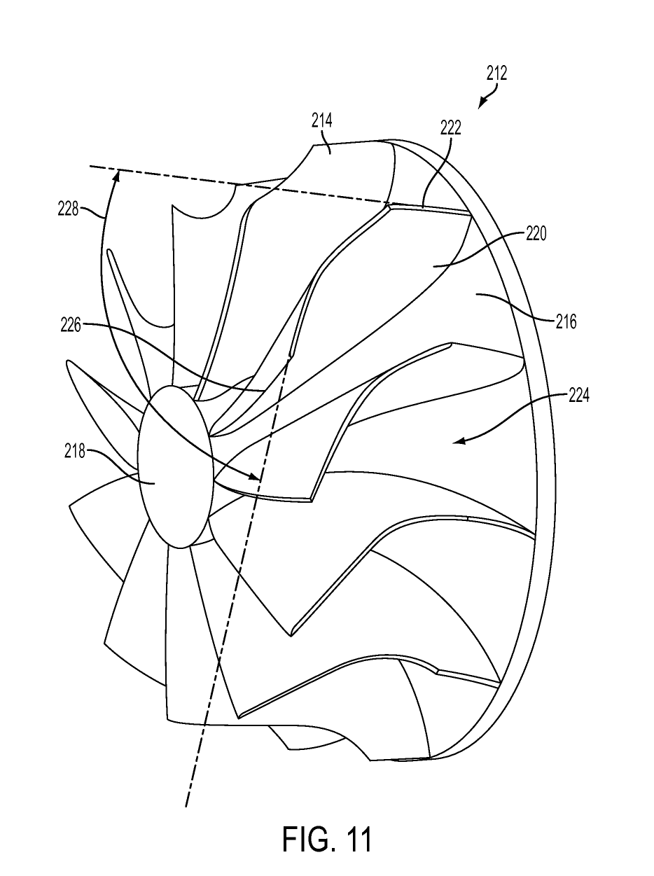

A cross section of the turbine 120 is shown in FIG. 9, with an enlarged detail view thereof shown in FIG. 10. In these views, the general shape of one of the gas passages 236 can be seen wrapped around a center opening 502 of the housing 215. As can also be seen, one of the turbine inlets 124 is fluidly connected to the passage 236. The turbine inlet 124 is formed as an opening in a flange 504 that is defined on the housing 215 and used to mount the turbine 120 to the engine 100 (FIG. 1).

As is best shown in FIG. 10, the gas passage 236 includes an inlet portion 506 and a turbine wheel supply portion 508. The turbine wheel supply portion 508 has a decreasing flow area as it extends peripherally around the opening 502 beginning from a transition area 510, which is disposed at the transition between the inlet and supply portions 506 and 508, and ending adjacent a tip 512 of a tongue feature 514 of the housing 215. The tongue feature 514 of the housing 215 is a wall separating the inlet portion 506 from the supply portion 508 of the housing 215. The tongue 514 is a feature generally found in all radial turbine housings and is also an area of the turbine housing that is prone to cracking and failure due to thermal stresses and high cycle fatigue. During operation, exhaust gas entering the turbine 120 via the inlet 124 passes through the inlet portion 506 and enters the turbine wheel supply portion 508 of the passage 236.

Exhaust gas entering the supply portion 508 of the passage 236 passes through the inlet openings in the ring 238, such as the openings 260, to radially and tangentially impinge onto the turbine wheel (not shown here), causing it to rotate. As gas passes through the openings 260 its pressure along the length of the passage will tend to decrease, which is avoided by the decreasing volume of the passage 236 as it extends around the opening 502.

An additional novel feature of the turbine 120 is the tip 512 of the tongue 514 has been shortened to a greater extent than what would have been necessary to merely provide clearance for installation of the ring 238 around the opening 502. As is best shown in FIG. 10, the tip 512 is disposed at a radial distance that forms a radial gap 516 with the outer diameter 518 of the ring 238. In this way, the performance and efficiency of the turbine may be improved because, in part, the static pressure of exhaust gas reaching the end of the supply portion 508 of the passage 236 is augmented by gas in the inlet portion 506 through the gap 516. Moreover, the reliability of the turbine 120 is improved because the shortened tongue 514 will be less prone to failure, such as from cracking or thermal stresses. In the illustrated embodiment, the tip 512 has a generally rounded shape that tangentially meets two curved sidewalls 520 and 522. The sidewall 520 is part of the inlet portion 506 and has a generally curved shape as it follows the passage 236. The sidewall 522 is part of the supply portion 508. In the illustrated embodiment, the tongue 514 extends radially around the opening 502 over a radial distance of about 70 degrees. A radius of the tip 512 is about 13% of the largest thickness of the tongue 514 and about 20% of the radius of the opening 124. The chord length of the sidewall 520 along the tongue 514 is about twice the diameter of the inlet opening 124.

In reference now to FIG. 11, the turbine wheel 212 is generally described. Each blade 214 of the wheel 212 is spaced at an equal radial distance from its adjacent blades 214 around the hub 216. In the illustrated embodiment, the turbine wheel 212 includes eleven blades 214 but any other number of blades may be used. Each blade 214 includes a body section 220 having a generally curved shape. The body section 220 is connected to the hub 216 along one side. A leading edge 222 is disposed at a radially outermost portion of the wheel 212 and is configured to admit a portion of a flow that operates to turn the wheel 212. As flow enters into radial channels 224 defined between the blades 214, the flow momentum pushes against the body sections of the blades 214, thus imparting a moment that turns the wheel 212. In the illustrated embodiment, for example, the wheel 212 is configured to rotate in a counterclockwise direction when viewed from the perspective of the fastener 218.

The hub 216 has a generally curved conical shape such that flow entering into the channels 224 from a radial direction is turned by about 90 degrees and exits the wheel in an axial direction. The rotation of the wheel 212 is augmented as it pushes against a discharge portion 226 of each blade 214. The discharge portion 226 has a generally curved shape that is disposed at a discharge angle 228 relative to an opposite portion of each blade 214 adjacent the inlet of the channel 224 as shown. In the illustrated embodiment, the discharge angle 228 is about 60 degrees, which is an angle that is steeper than corresponding angles used on typical turbines by about 4 to 5 degrees.

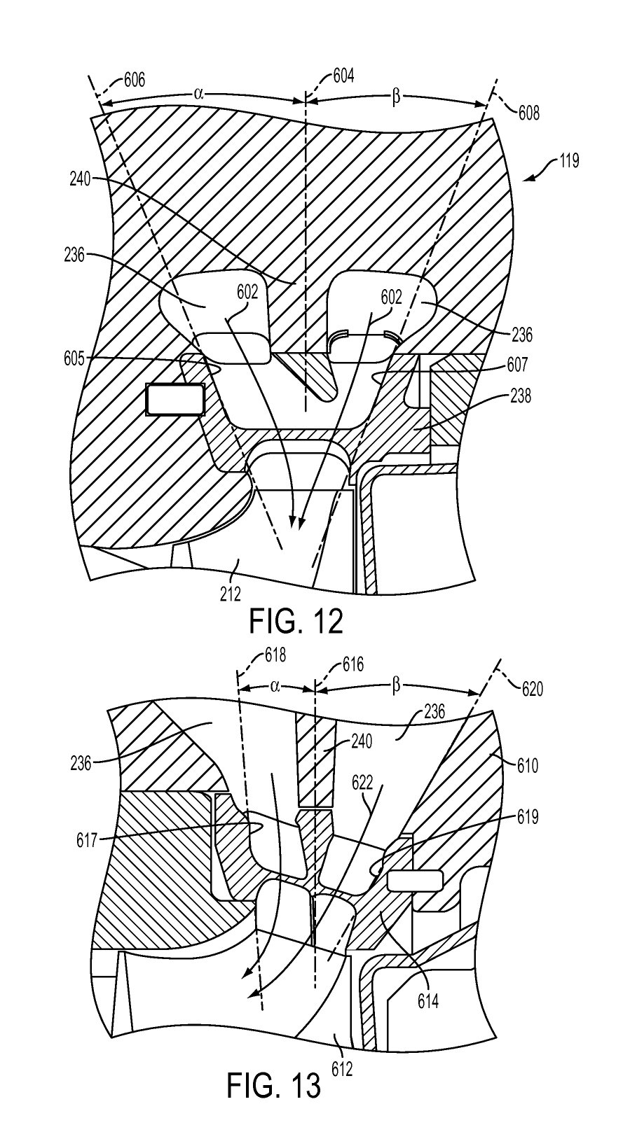

The wheel 212 shown in FIG. 11 is generally configured to receive gas provided in a radial direction relative to the wheel 212. The direction of gas flow 602, which is denoted by arrows, can be determined by the general shape of the nozzle ring 238, as is more particularly shown and described relative to FIG. 12. FIG. 12 is a cross section of the turbocharger 119 (FIG. 2). As shown in this illustration, a plane 604 extending radially relative to the axis of rotation of the wheel 212 is shown at a location substantially bifurcating the divider wall 240. An outer, generally frusto-conical internal contour surface 605 of the inner ring 242 extends at an angle, α, relative to the plane 604 along a line denoted as 606 in the cross section of FIG. 12. Similarly, an inner contour surface 607 of the inner ring 242 extends at an angle, β, relative to the plane 604 along a line 608. In embodiments using a radial flow wheel, such as wheel 212, the angles α and β are substantially equal such that a symmetrical gas momentum velocity condition is created around the divider wall 240. This symmetrical gas velocity around the divider wall 240 provides gas travelling generally in a radial direction relative to and toward the wheel 212.

Depending on the design of the wheel, however, a mixed-flow gas velocity may alternatively be provided, which includes an axial-flow component in addition to the radial-flow discussed above. In general, turbines can be configured for radial-flow, axial-flow (for example, such as those used in jet engines), or a hybrid type of flow that includes radial and axial components, which will hereinafter be referred to as “mixed” flow to denote that the flow includes radial and axial flow characteristics.

FIG. 13 is a cross section of a mixed flow turbine 610. The turbine 610 includes a mixed-flow turbine wheel 612 that receives exhaust gas passing through a nozzle ring 614. In this embodiment, although the nozzle ring 614 includes many of the same features as previously described, it is also configured to impart an axial component to the gas momentum velocity of gas provided to the wheel 612. More particularly, a plane 616 extending radially relative to the axis of rotation of the wheel 612 is shown at a location substantially bifurcating the divider wall 240. In this embodiment, the outer, generally frusto-conical internal contour surface 617 of the nozzle ring 614 extends at an angle, α, relative to the plane 616 along a line denoted as 618 in the cross section of FIG. 13. Similarly, the inner contour surface 619 of the nozzle ring 614 extends at an angle, β, relative to the plane 616 along a line 620. Unlike the embodiment shown in FIG. 12, the angles α and β in this embodiment are different, with angle β being larger than angle α such that an asymmetrical gas momentum velocity condition is created around the divider wall 240. This asymmetrical gas velocity around the divider wall 240 provides exhaust gas having momentum components provided both radially and axially relative to and toward the wheel 212. In the illustration of FIG. 13, solid line arrows 622 denote the general direction of travel for gas provided to the turbine wheel 612.

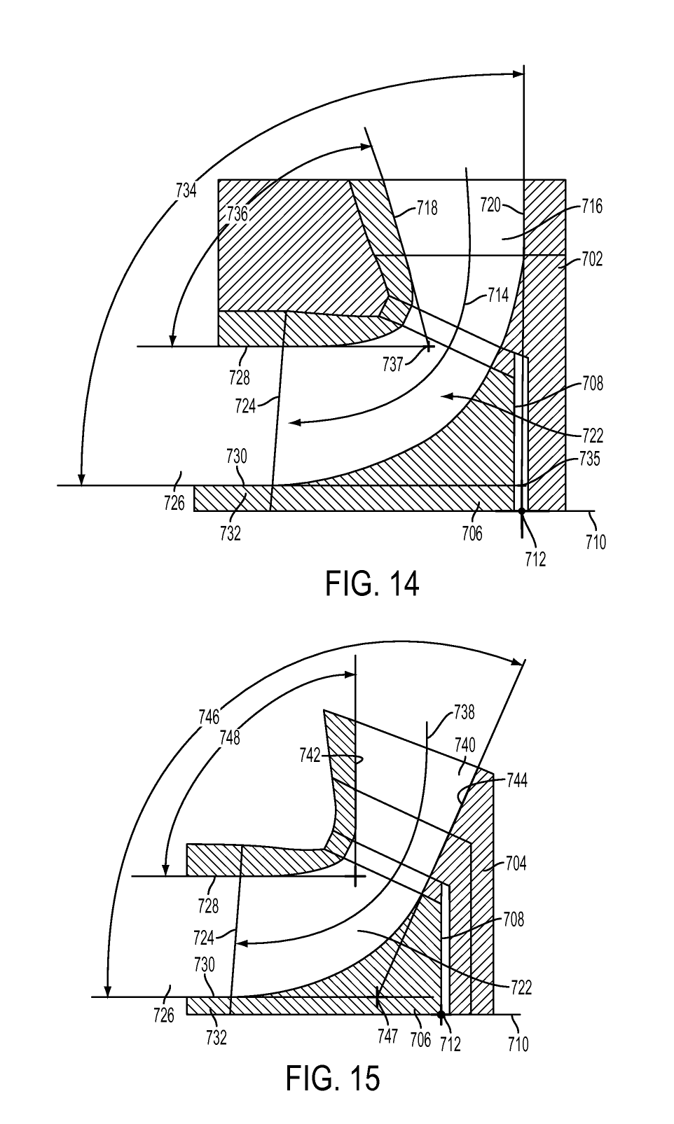

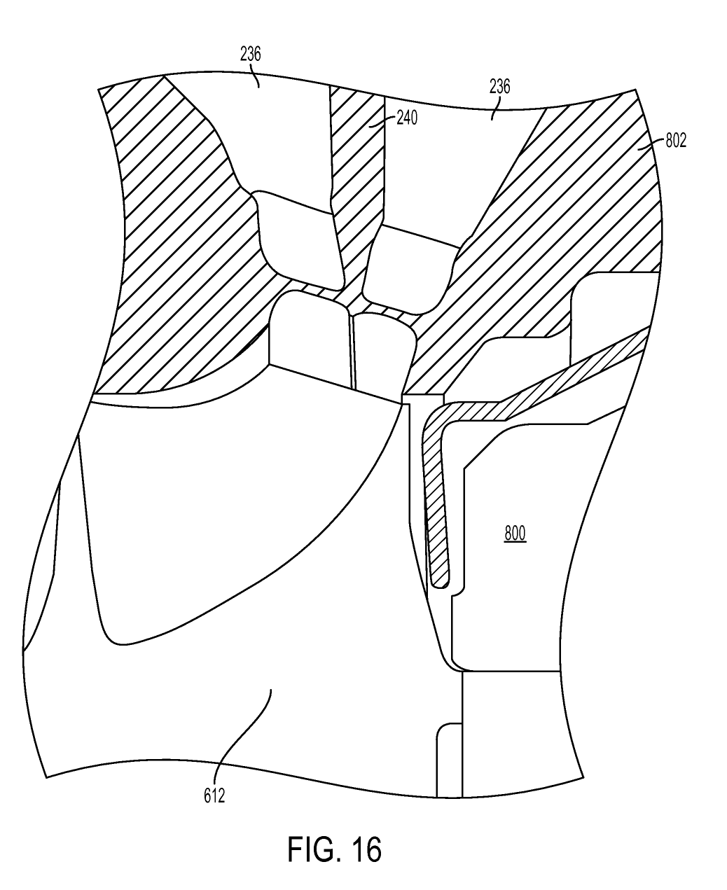

When the gas flows 602 (FIGS. 12) and 622 (FIG. 13) are qualitatively compared as illustrated, it can be seen that the mixed-flow turbine 610 can operate using a turbine wheel configured to operate with gas having axial flow characteristics. This type of operation can be beneficial in part because the pressure drop of gas passing through the turbine 610 is lower than that of turbine 119. Two qualitative charts showing certain geometrical characteristics of two different mixed flow turbines in accordance with the disclosure are shown in FIGS. 14 and 15 for illustration. The illustrations in these figures can be considered as representing detail cross section views of the gas flow transition between a first turbine housing 702 (FIG. 14) or second turbine housing 704 (FIG. 15) into a turbine wheel 706.

In each illustration, a radial plane 708 is defined to coincide with an inner portion of the turbine wheel 706 as shown. An axis 710 is defined along a centerline and rotation axis of the wheel 706. The radial plane 708 and axis 710 intersect the plane of the cross sections illustrated in FIGS. 14 and 15 to define an orthogonal coordinate system having an origin at 712 for the purpose of the following discussion.

In reference now to FIG. 14, a gas flow path 714, which is generally denoted by a solid lined arrow, passes through an annular passage 716 formed in the turbine housing 712, which may further include a nozzle ring having vanes 246 (see, for example, FIG. 4) disposed within the annular passage 716 as previously described. The annular passage 716 is defined between an outboard inlet surface 718 and an inboard inlet surface 720, which are shown in cross section. Exhaust gas from the annular passage 716 is provided to operate the wheel 706 as it passes through areas 722 defined between the blades 724 of the turbine wheel 706. Gas exiting the wheel 706 passes through a generally cylindrical turbine outlet volume 726 that is defined between an outer outlet bore 728 and, at least partially, an outer portion 730 of the turbine shaft 732.

As can be seen in the cross section of FIG. 14, an inner angle 734 has an inner centerpoint 735 and is defined between the inboard inlet surface 720 and the outer portion 730 of the turbine shaft 732 to be about 90 degrees. An outer angle 736 has an outer centerpoint 737 and is defined between the outboard inlet surface 718 and the outlet bore 728. The outer angle 736 is a more acute and in the embodiment illustrated in FIG. 14 is about 75 degrees. As can be seen in FIG. 14, the inner centerpoint 735 is located close to the origin 712.

In reference now to FIG. 15, the gas flow path 738, which is generally denoted by a solid lined arrow, is generally less curved than the flow path 714 of the embodiment shown in FIG. 14 because of the general shape of the surrounding geometry. More particularly and in reference to FIG. 15, where features and elements that are the same or similar corresponding features and elements previously described are denoted by the same reference numerals as previously used for simplicity, the annular passage 740 is defined between outboard and inboard inlet surfaces 742 and 744. In this embodiment, an inner angle 746 defined between the inboard inlet surface 744 and the outer portion 730 of the turbine shaft 732 has a centerpoint 747 that is close to the axis 710 but away from the origin 712 in a direction toward the generally cylindrical turbine outlet volume 726. When compared to the inner angle 734 (FIG. 14), the inner angle 746 of the embodiment shown in FIG. 15 is larger and, as shown, measures about 115 degrees. The outer angle 748 defined between the outboard inlet surface 742 and the bore 728 in this embodiment is also larger than the outer angle 736 (FIG. 14) and measures about 90 degrees.

With respect to the two alternative embodiments for the mixed flow turbines 702 and 704, as shown in FIGS. 14 and 15, respectively, it can be seen that the general shape and inlet angles of the annular openings in the turbine housings 702 and 704 providing gas flow to the turbine wheel 706 can be adjusted to provide steeper or shallower angles of incidence of exhaust gas flowing toward the turbine wheel 706. In this way, steeper entry angles such as those shown in FIG. 14 have a more pronounced radial flow characteristic, while shallower angles such as those shown in FIG. 15 have a more pronounced axial flow characteristic. These and other design parameters, coupled with the particular design of a turbine wheel, can be adjusted and selected to provide optimal turbocharger performance for each particular engine configuration. Selection of the appropriate parameters that correspond to a particular engine can involve the consideration of various turbocharger operating conditions, such as exhaust gas temperature, pressure and flow rate, desired pressure difference to drive the turbine, turbine size, and others, desired turbine A/R ratio, and others.

Apart from the performance characteristics of the various turbines described thus far, the structure of any of the embodiments described thus far can be modified for ease of manufacture. For example, one embodiment for a turbine 800 is shown in FIG. 16. The turbine 800 is, in many ways, similar to the mixed flow turbine 610 shown in cross section in FIG. 13, except that in this embodiment the nozzle ring 614 (FIG. 13) is integrated with the turbine housing 610 (FIG. 13) to provide a mixed-flow, nozzled turbine housing 802. The nozzled turbine housing 802 retains all the desired functional characteristics previously described, but by virtue of the integration of the nozzle ring into the housing of the turbine provides a lower part count, which can reduce assembly complexity and cost as well as reduce the time required to service or remanufacture the turbine 802.

### INDUSTRIAL APPLICABILITY

The present disclosure is applicable to radial and mixed-flow turbines, especially those turbines used on turbocharged internal combustion engines. Although an engine 100 having a single turbocharger is shown (FIG. 1), any engine configuration having more than one turbocharger in series or in parallel arrangement is contemplated.

As is known, turbine performance depends in part on the available energy content or enthalpy per unit of gas driving the turbine. The ratio of an ideal or maximum turbine wheel velocity, which depends on the energy available to drive the turbine wheel, over the actual tangential velocity of the turbine wheel blades is commonly used to quantify turbine efficiency in a non-dimensional fashion. Accordingly, the ratio of the actual tangential velocity of a blade, U, over an ideal velocity, C, can be experimentally determined for any given pressure ratio or difference applied to a turbine, for example, on an engine or on a gas stand. The ratio of U/C is thus a non-dimensional indication of a turbine's operating state at which the efficiency of the turbine may be determined to empirically characterize the available energy and blade tangential velocity with respect to turbine efficiency. Alternatively, the U/C ratio may also be defined as the ratio of circumferential speed and the jet velocity corresponding to an ideal expansion from an inlet to an outlet condition of the turbine.

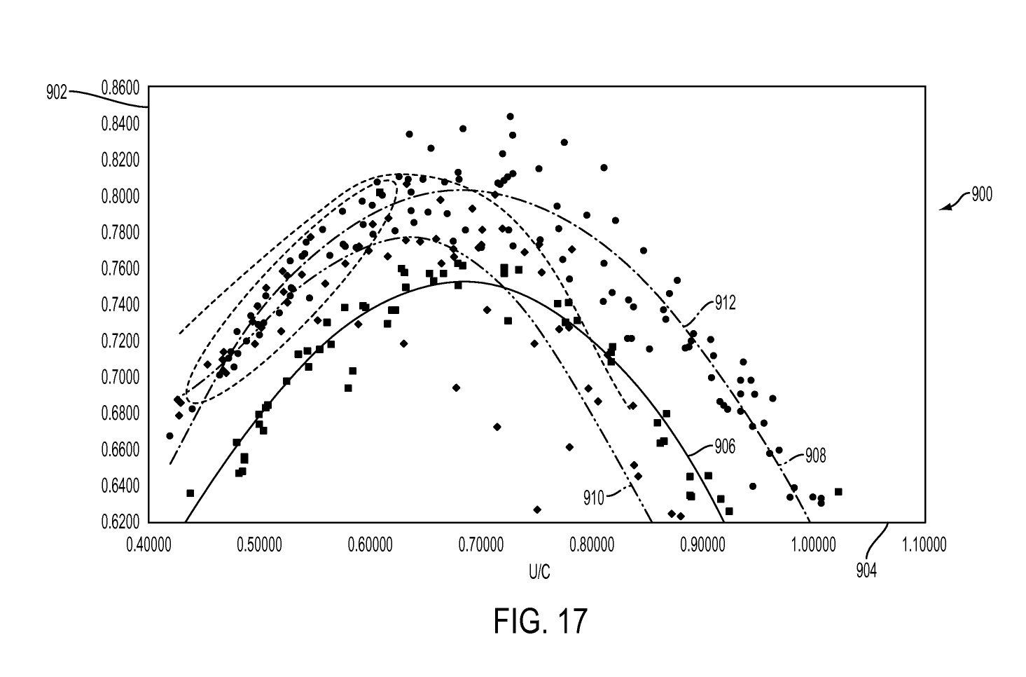

In FIG. 17, a qualitative chart 900 showing turbine efficiency 902 is plotted against the U/C ratio 904 for various embodiments of turbines the turbine, for example, a radial turbine 120, a mixed-flow turbine 610, a mixed-flow, nozzled turbine 802, and a baseline turbine for comparison. The data illustrated in graphical form in the chart 900 was acquired on a gas stand and/or estimated using simulation models for all turbine types having the same or comparable frame sizes and similar pressure ratios.

In reference now to the chart 900, a first efficiency curve 906 (shown in solid line) was acquired from successive runs of the baseline turbine. As can be seen from the chart 900, the turbine efficiency was maximum at about 76% while the baseline turbine was operating at a U/C ratio of about 66%. A second efficiency curve 910 represents the performance of a radial, nozzled turbine operating at substantially the same operating conditions as those used when acquiring the plotted information from the baseline turbine. As can be seen from the second efficiency curve 910, the radial, nozzled turbine had an efficiency of about 80% at a U/C of about 70%. In other words, the addition of the features consistent with the nozzle ring added to a baseline radial turbine resulted in an efficiency increase of about 4% points. The extent of increase in turbine efficiency, which in different turbine configurations was observed to be as much as 7.5% points between the baseline and nozzled radial turbines was unexpected.

A third efficiency curve 910 represents the performance of a mixed flow turbine. The third efficiency curve shows a peak efficiency of about 78% at a U/C of about 63%. In other words, the modification of the baseline turbine for mixed flow operation provided a performance increase of about 2% points at a lower U/C. A fourth efficiency curve 912 represents an estimation based on simulation of the performance of a mixed-flow nozzled turbine. Here, the peak efficiency is expected to be about 81% at a U/C of about 60%. In other words, the addition of nozzle vanes and of features that provide for mixed flow is expected to improve the efficiency of a turbine about 5% points over the baseline design, which is a considerable improvement. Additional empirical data on this and other testing is available but not presented herein for brevity.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A turbine, comprising:
a turbine housing including at least two gas passages having substantially the same flow area and disposed on either side of at least one divider wall;
a turbine wheel having a plurality of blades;
a nozzle ring connected to the turbine housing and disposed around the turbine wheel, the nozzle ring including an inner ring disposed adjacent the divider wall and at least one outer ring;
a plurality of vanes fixedly disposed between the inner and outer rings, the vanes defining a plurality of inlet openings therebetween that are in fluid communication with a slot formed in the nozzle ring and surrounding the turbine wheel;
wherein the inner ring is disposed to block a portion of the inlet openings that fluidly communicate with one of the at least two gas passages in the turbine housing.

2. The turbine of claim 1, wherein the nozzle ring is integrally formed with the turbine housing.

3. The turbine of claim 1, wherein the nozzle ring includes two outer rings such that the inner ring is disposed between the two outer rings and each of the plurality of vanes extends between the two outer rings.

4. The turbine of claim 1, wherein the plurality of vanes is arranged symmetrically around a central opening of the nozzle ring such that inclined flow channels are defined between adjacent vanes, the inclined flow channels being configured to direct a flow momentum of gas passing through the inclined flow channels generally tangentially and radially inward toward an inner diameter of the turbine wheel.

5. The turbine of claim 1, wherein the nozzle ring is disposed within a bore formed in the turbine housing, and wherein the turbine further includes a retainer disposed to retain the nozzle ring within the bore of the housing, the retainer extending peripherally around the nozzle ring and connected to the housing by fasteners.

6. The turbine of claim 1, wherein the nozzle ring defines first and second pluralities of inlet openings therethrough, the second plurality of inlet openings having a smaller flow area as compared to the first plurality of inlet openings such that an asymmetrical flow restriction to gas present in one of the gas passages over the other is provided.

7. The turbine of claim 6, wherein the first and second pluralities are defined on either side of the inner ring, and wherein the asymmetrical flow restriction is accomplished by providing a slant to the inner ring relative to first and second outer rings.

8. The turbine of claim 6, wherein the inner ring has a divider wall extension portion having a generally oblique trapezoidal cross section shape having a flat base, along which it contacts the divider wall, and a generally rounded opposite base, wherein a thickness of the divider wall extension portion in a radial direction relative to the turbine wheel is about 40% of a total radial thickness of each of first and second outer rings, and wherein the divider wall extension portion is disposed at an angle of about 60 degrees relative to the flat base.

9. The turbine of claim 1, wherein the turbine housing includes a tongue having a tip defined adjacent an outer diameter of the nozzle ring, the tip disposed at a radial distance that forms a radial gap between the outer diameter of the nozzle ring and the tip.

10. The turbine of claim 1, wherein each of the plurality of blades has a discharge angle of about 60 degrees.

11. The turbine of claim 1, wherein the turbine housing forms an outboard inlet surface disposed adjacent the nozzle ring along one of the at least two gas passages, and an inboard inlet surface disposed adjacent the nozzle ring along an other of the at least two gas passages, the outboard inlet surface forming a first angle with a plane extending along the divider wall, the inboard inlet surface forming a second angle with the plane such that the second angle is larger than the first angle.

12. An internal combustion engine, comprising:
a divided turbine having first and second inlets;
a first plurality of cylinders connected to a first exhaust conduit, the first exhaust conduit being connected to the first inlet of the divided turbine;
a second plurality of cylinders connected to a second exhaust conduit, the second exhaust conduit being connected to the second inlet of the divided turbine;
a balance valve disposed to selectively route exhaust gas from the first exhaust conduit to the second exhaust conduit;
an exhaust gas recirculation (EGR) system including a valve that selectively fluidly connects the first exhaust conduit with an intake system of the engine;
wherein the divided turbine includes:
a turbine housing including at least two gas passages having substantially the same flow area and disposed on either side of at least one divider wall;
a turbine wheel having a plurality of blades;
a nozzle ring connected to the turbine housing and disposed around the turbine wheel, the nozzle ring including an inner ring disposed adjacent the divider wall and at least one outer ring;
a plurality of vanes fixedly disposed between the inner and outer rings, the vanes defining a plurality of inlet openings therebetween that are in fluid communication with a slot formed in the nozzle ring and surrounding the turbine wheel;
wherein the inner ring is disposed to block a portion of the inlet openings that fluidly communicate with one of the at least two gas passages in the turbine housing.

13. The internal combustion engine of claim 12, wherein the nozzle ring is integrally formed with the turbine housing.

14. The internal combustion engine of claim 12, wherein the nozzle ring includes two outer rings such that the inner ring is disposed between the two outer rings and each of the plurality of vanes extends between the two outer rings.

15. The internal combustion engine of claim 12, wherein the plurality of vanes is arranged symmetrically around a central opening of the nozzle ring such that inclined flow channels are defined between adjacent vanes, the inclined flow channels being configured to direct a flow momentum of gas passing through the inclined flow channels generally tangentially and radially inward toward an inner diameter of the turbine wheel.

16. The internal combustion engine of claim 12, wherein the nozzle ring is disposed within a bore formed in the turbine housing, and wherein the divided turbine further includes a retainer disposed to retain the nozzle ring within the bore of the housing, the retainer extending peripherally around the nozzle ring and connected to the housing by fasteners.

17. The internal combustion engine of claim 12, wherein the nozzle ring defines first and second pluralities of inlet openings therethrough, the second plurality of inlet openings having a smaller flow area as compared to the first plurality of inlet openings such that an asymmetrical flow restriction to gas present in one of the gas passages over the other is provided.

18. The internal combustion engine of claim 17, wherein the first and second pluralities are defined on either side of the inner ring, and wherein the asymmetrical flow restriction is accomplished by providing a slant to the inner ring relative to first and second outer rings.

19. The internal combustion engine of claim 17, wherein the inner ring has a divider wall extension portion having a generally oblique trapezoidal cross section shape having a flat base, along which it contacts the divider wall, and a generally rounded opposite base, wherein a thickness of the divider wall extension portion in a radial direction relative to the turbine wheel is about 40% of a total radial thickness of each of first and second outer rings, and wherein the divider wall extension portion is disposed at an angle of about 60 degrees relative to the flat base.

20. The internal combustion engine of claim 12, wherein the turbine housing includes a tongue having a tip defined adjacent an outer diameter of the nozzle ring, the tip disposed at a radial distance that forms a radial gap between the outer diameter of the nozzle ring and the tip.

21. The internal combustion engine of claim 12, wherein each of the plurality of blades has a discharge angle of about 60 degrees.

22. The internal combustion engine of claim 12, wherein the turbine housing forms an outboard inlet surface disposed adjacent the nozzle ring along one of the at least two gas passages, and an inboard inlet surface disposed adjacent the nozzle ring along an other of the at least two gas passages, the outboard inlet surface forming a first angle with a plane extending along the divider wall, the inboard inlet surface forming a second angle with the plane such that the second angle is larger than the first angle.

23. A nozzle ring for a turbine, comprising:
an inner ring disposed adjacent a divider wall of a turbine housing when the nozzle ring is disposed within the turbine housing, the inner ring defining a divider wall extension portion having a generally trapezoidal shape that includes a substantially flat base, which is adapted to be disposed adjacent the divider wall, a rounded base, and two generally straight edges connected to the flat base and tangentially meeting ends of the rounded base when viewed in section taken along a diameter of the nozzle ring;
at least one outer ring having a radial thickness and disposed at an axial distance relative to the inner ring;
a plurality of vanes fixedly disposed between the inner and outer rings, the vanes defining a plurality of inlet openings therebetween that are adapted to be in fluid communication with one or more gas passages defined in the turbine housing;
wherein the divider wall extension portion has a radial thickness of about 40% of the total radial thickness of the at least one outer ring;
wherein the divider wall extension portion is slanted by about 60 degrees relative to the flat base such that one of the two straight edges is about 60% of the length of the other of the two straight edges;
wherein a radius of the rounded base is about 16% of the length of the longer of the two straight edges and about 25% of the length of the shorter of the two straight edges.
